(19) United States
(12) Patent Application Publication
(10) Pub. No.: US 2018/0096262 A1
(43) Pub. Date: Apr. 5, 2018

(54) METHOD FOR CONTROL OF OUTPUTTING SEQUENCE INFORMATION AND SERVER SUPPORTING THE SAME

(71) Applicant: Minseok CHO, Suwon-si, Gyeonggi-do (KR)

(72) Inventor: Minseok CHO, Suwon-si, Gyeonggi-do (KR)

(21) Appl. No.: 14/787,101

(22) PCT Filed: Oct. 14, 2015
(86) PCT No.: PCT/KR2015/010808

§ 371 Date: Oct. 26, 2015

(51) Int. Cl. G06Q 10/02; H04L 29/08; H04W 4/02; H04L 12/58; G06F 3/14

(52) U.S. Cl. CPC G06Q 10/02; H04L 67/306; H04W 4/02; G06Q 30/0241; H04L 51/32; G06F 3/1454; H04W 4/023

(57) ABSTRACT

Disclosed is a method for control of outputting sequence information and server supporting the same. In accordance with an embodiment of the present invention, a server of controlling output of sequence information is provided. The server comprises a communication unit configured to receive standby application information for using a service; a control unit configured to: determine a standby sequence of user based on the standby application information; generate an object related with the standby application information and configure a sequence information screen in which the generated object and at least one object generated in advance are visually arranged in accordance with the standby sequence corresponding to each of objects; and transmit, through the communication unit, the configured sequence information screen and a control signal of controlling the configured sequence information screen to be outputted to a sequence information output device.

### TECHNICAL FIELD

Various embodiments of this invention are for the controlling method of visually outputting the sequence information of service user and the server and system for supporting this.

### RELATED ART

Generally, when the number of standing by customer is large, the store which provides goods or service delivers the number ticket which is manually prepared to the standing by customer or provides the number ticket printed by the number ticket preparing machine to the standing by customer.

By providing these kinds of standby tickets, the store prevents confusion during the standby by allowing the standing by customers to estimate the standby time themselves, and furthermore, useful advertising effect may also be presented to the possible customers passing the store through the standby line generated by the customers.

In addition, recently, before visiting the store, customers apply the advance standby appointment through the mobile application, and with the basis of the applied standby appointment information, the service of providing the sequence information related with the standby information to the corresponding customer is under way from the application server.

### SUMMARY

When the appointment of user is progressed through the mobile application as in the case of past, it has the advantage from the viewpoint of the user that the appointment can conveniently be progressed, however, from the viewpoint of the store, the visual sight of queuing customers may not be known to the adjacent prospective customers. Especially, for the store such as restaurant, the scenery of not having the standby line can inadvertently be interpreted as the mediocre taste of cuisines to other customers, which can be resulted in a greater damage.

In accordance with an embodiment of the present invention, a server of controlling output of sequence information is provided. The server comprises a communication unit configured to receive standby application information for using a service; a control unit configured to: determine a standby sequence of user based on the standby application information; generate an object related with the standby application information and configure a sequence information screen in which the generated object and at least one object generated in advance are visually arranged in accordance with the standby sequence corresponding to each of objects; and transmit, through the communication unit, the configured sequence information screen and a control signal of controlling the configured sequence information screen to be outputted to a sequence information output device.

In accordance with various embodiments of the present invention, the control unit is further configured to transmit the standby sequence and the generated object to a user terminal through the communication unit.

In accordance with various embodiments of the present invention, the control unit is further configured to: transmit a sequence arriving information to the user terminal though the communication unit at the time corresponding to the standby sequence; and configure the sequence information screen such that the object corresponding to the standby sequence is displayed differently from other objects on the sequence information screen, and transmit the configured sequence information screen to the sequence information output device.

In accordance with various embodiments of the present invention, the standby application information includes at least one of information for the number of people to use the service, nickname information of service user, location information of the user terminal, photograph image information of user, and ID information of user.

In accordance with various embodiments of the present invention, the object related to the standby application information is generated based on at least one of: the location information of the user terminal; an image information automatically generated from the server; and an image information obtained through the sequence information output device.

In accordance with various embodiments of the present invention, the control unit is further configured to provide a discount coupon to the user terminal through the communication unit when the standby application information or the standby sequence meets a pre-set condition.

In accordance with various embodiments of the present invention, the pre-set condition includes at least one of: a condition that the standby application information is received from a previous user terminal registered to the server; a condition that location of the user terminal is located within a pre-set distance from the sequence information output device; and a condition that the standby sequence is equal to or greater than a pre-set sequence.

In accordance with various embodiments of the present invention, the control unit is further configured to: receive a message from the user terminal through the communication unit; and transmit, to the sequence information output device, the message and a signal which controls the message to be included in the sequence information screen or to be outputted at a location adjacent to the sequence information screen.

In accordance with various embodiments of the present invention, a method for controlling output of sequence information is provided. The method comprises receiving a standby application information for using a service; determining a standby sequence of user based on the standby application information; generating an object related with the standby application information; configuring a sequence information screen in which the generated object and at least one object generated in advance are visually arranged in accordance with standby sequence corresponded to each of the objects; and transmitting, to a sequence information output device, the configured sequence information screen and a control signal which control the sequence information screen to be outputted.

In accordance with an embodiment of the present invention, a computer-readable storage media having a program configured to control outputting of sequence information is provided. The program comprises receiving standby application information for using a service; determining a standby sequence of user based on the standby application information; generating an object related with the standby application information; configuring a sequence information screen in which the generated object and at least one object generated in advance are visually arranged in accordance with standby sequence corresponded to each of the objects; and transmitting, to a sequence information output device, the configured sequence information screen and a control signal which control the sequence information screen to be outputted.

In accordance with an embodiment of the present invention, a system of controlling output of sequence information is provided. The system comprises a user device for transmitting standby application information for using a service to a server; the server for determining a standby sequence of user based on the standby application information, generating an object related with the standby application information, configuring a sequence information screen in which the generated object and at least one object generated in advance are visually arranged in accordance with standby sequence corresponded to each of the objects, and transmitting to a sequence information output device the configured sequence information screen and a control signal which control the sequence information screen to be outputted; and the sequence information output device for outputting the received sequence information from the server.

### DESCRIPTION OF THE DRAWINGS

The above and/or other aspects will become apparent and more readily appreciated from the following description of exemplary embodiments, taken in conjunction with the accompanying drawings of which:

FIG. 1 is the configuration drawing for the system 101 which controls the outputting of sequence information in accordance with various embodiments of this invention.

FIG. 2 is the block diagram of the server 100 which controls the output of sequence information in accordance with the various embodiments of this invention.

FIG. 3 is the flow diagram indicating the actions of controlling the output of sequence information from the server 100 in accordance with the various embodiments of this invention.

FIG. 4 is the block diagram of sequence information output device 300 which outputs the sequence information in accordance with the various embodiments of this invention.

FIG. 5 is the illustration diagram which shows the sequence information output device 200 in accordance with the various embodiments of this invention.

FIG. 6 is the illustration diagram which shows sequence information screen 600 in accordance with the various embodiments of this invention.

### DETAILED DESCRIPTION

Reference will now be made in detail to exemplary embodiments, examples of which are illustrated in the accompanying drawings. However, the present inventive concept may be embodied in many different forms and should not be construed as being limited to the exemplary embodiments set forth herein. Rather, these exemplary embodiments are provided so that the present disclosure will be thorough and complete, and will fully convey the scope of the present inventive concept to those skilled in the art, and the spirit and scope of the present inventive concept should be defined by the appended claims.

Without separate definitions, all terms (including technical and scientific terms) used in the present description may be used for the meanings commonly understandable to those having ordinary skill in the art. In addition, the terms generally used and having definitions in dictionary, unless otherwise defined obviously in particular, should not be ideally or exaggeratedly interpreted.

The terms used in the present description are to explain the exemplary embodiments, not to limit the present invention thereto. In the present description, a singular form of word also includes a plural form thereof unless otherwise noted. The term “comprises” and/or “comprising” is not excluding the meaning that one or more elements other than the said element may exist or be added.

Hereinafter, exemplary embodiments of the present inventive concept will be described in detail with reference to the accompanying drawings. In the drawings, like reference numerals refer to like elements.

The advantage and characteristic of the present invention and the method of accomplishing these will be clarified by referring to the embodiment described later in detail. However, this invention will not be limited to the embodiment described hereafter, but will be embodied with various different types, and this embodiment is only to be provided for making perfection of the start of this invention, and precisely informing the category of the invention to the person with normal degree of knowledge in the field of the technology belonged to this invention, and this invention will only be defined by the category of the claims.

Unless otherwise defined, all the terms (including technological and scientific terms) used in this invention will be able to be used as the meaning which can commonly be understood to the person with normal degree of knowledge in the field of the technology belonged to this invention. In addition, the terms defined in ordinary dictionary will not ideally or excessively be interpreted unless they have clearly and specifically been defined.

In the followings, the method of controlling the output of sequence information in accordance with various embodiments, server, and system are described by referring to the attached drawings. In this document, the term user can be used for referring to the person who uses the user terminal for the sake of sequence standby application for a specific service.

The term “service” used in this document can generally be used for referring to the producing, selling or lending the specific goods on offline or providing a specific service, or the service related with the sequence standby application provided by the server 100 of this invention.

In addition, the term “sequence information” used in this document can be the concept of containing at least one of the standby application information, object, sequence information screen, sequence arriving information, and message which are mentioned in the various embodiments of this invention.

In addition, the term “standby application information” used in this document can be the information inputted at any time through the user terminal as the appointment application for the sake of using the specific service (example: dining in restaurant). This standby application information can be inputted at the user terminal 300 in accordance with the execution of application. In addition, the above standby application information can be inputted into the server 100 by the service provider terminal. Furthermore, the above standby application information can also be inputted through the sequence information output device 200. Therefore, this standby application information can be transmitted to the server 100 through the application installed at the user terminal (300, example: cellular phone) of the service user, or through the sequence information output device 200, or from the service provider terminal. According to the various embodiments, standby application information can include at least one of the information for the number of persons to use the corresponding service, nickname of service user, location of the above user terminal, photographed image of user, and ID of user.

In addition, the term “object” used in this document can be the server 100, sequence information output device 200, or the contents which can be displayed on the user terminal 300. According to the various embodiments, the object can be the text, image, photograph, static image, dynamic image, thumbnail, or the UI item with various types and it can have various sizes and colors.

In addition, the term “sequence information screen” used in this document can be the screen which includes at least one of the standby application information, sequence information, message, and object. The specific embodiment constituting this sequence information screen will be described hereafter.

In addition, the term “sequence arriving information” used in this document can be the text, image or voice data informing that the standby sequence of specific user is arrived for the use of corresponding service.

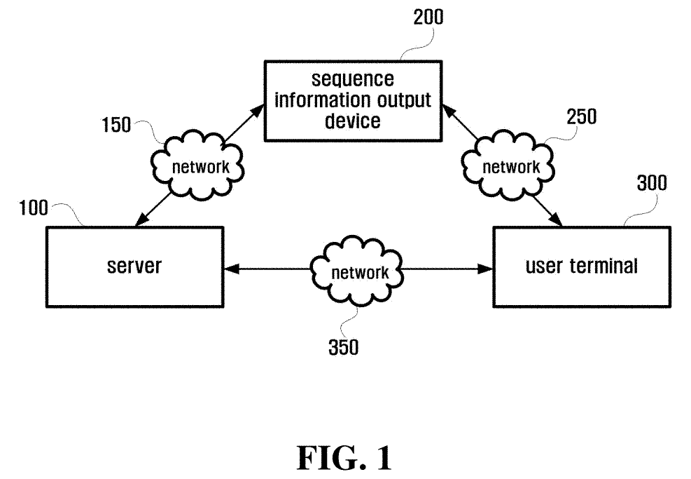

FIG. 1 is the configuration drawing for the system 101 which controls the outputting of sequence information in accordance with various embodiments of this invention.

The system 101 which controls the outputting of sequence information can include the server 100, sequence information output device 200, user terminal 300, and network 150,250, and 350. According to the various embodiments, the system 101 can omit at least one of the components of FIG. 1 or additionally possess another component. For example, the network 250 between sequence information output device 200 and user terminal 300 can be omitted, and the sequence information output device 200 and user terminal 300 can be connected through the communication module.

The system 101 which possesses the configuration as above can be constituted with the sequence information output device (200, example: kiosk) which can be installed at the location near to the store that provides the service, and the server 100 which performs the control in such a way that the sequence information of customers are visually outputted from the sequence information output device 200, and the user terminal 300 which requests the sequence standby application to the server 100.

According to the various embodiments, the system 101 which outputs the sequence information can include the user terminal of transmitting the standby application information for using the service to the server; the server 100 of determining the standby sequence with the basis of the above standby application information, generating the object related with the above standby application information, constituting the sequence information screen in which the above generated object and at least one of the objects generated in advance are visually arranged in accordance with the corresponding standby sequence, and transmitting the control signal which makes the above sequence information screen displayed to the sequence information output device 200; and the sequence information output device 200 of outputting the standby information screen received from the above server.

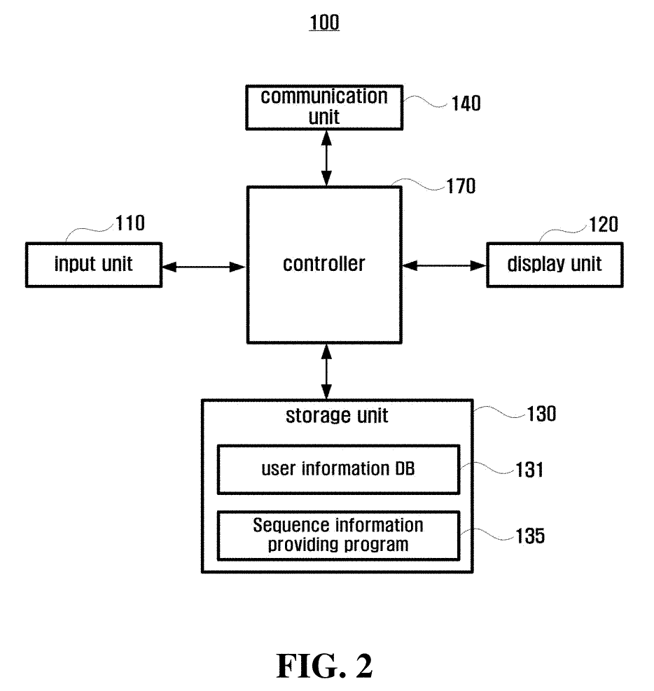

Server 100 is the device constituted in such a way that the output of sequence information is controlled by transmitting the data and control signal with the sequence information output device 200, and the specific illustration for this will be described with FIG. 2.

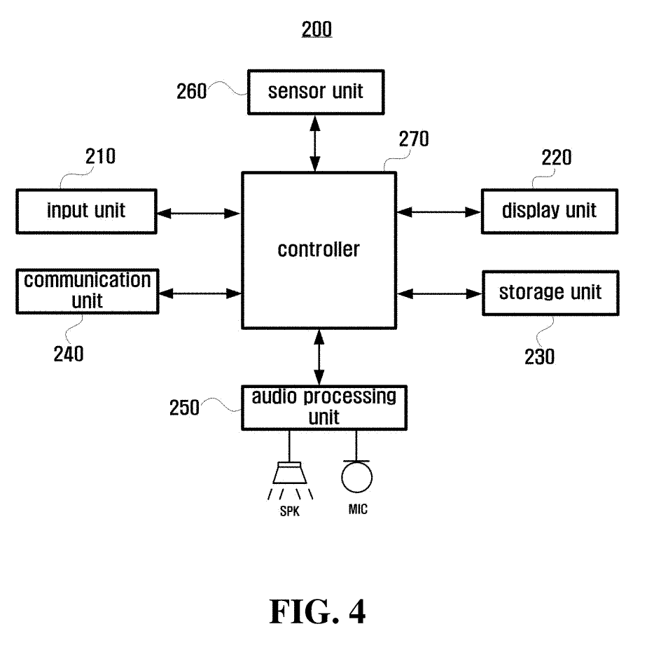

Sequence information output device 200 is the device of outputting the sequence information by receiving the data and control signal from the server 100. This kind of sequence information output device 200 can be the electronic device of various types equipped with display unit and communication unit as in the case of kiosk, and it can be installed at the location (example: near to the entrance of the store) adjacent to the point of providing the service (example: store). Specific configuration of the sequence information output device 200 will be described later in this document with FIG. 4.

User terminal 300 is the means utilized by the user for conducting the sequence standby application to the server 100 through the network 250, and 350 for the specific service, and the web browser or application for transmitting the standby application information can be installed. For this kind of user terminal 300, anything can be applied as long as it is the electronic device equipped with communicating function. For example, various devices such as the smart phone, tablet, mobile phone, desktop PC (personal computer), laptop PC (personal computer), net book computer, workstation, PDA (personal digital assistant), PMP (portable multimedia player), MP3 player, server, or wearable device, and so forth can be the user terminal 300.

The user terminal 300 can include at least one of the components of server 100 and sequence information output device 200. For example, the user terminal 300 can include the display unit (example: display module or touch screen), input unit (example: physical key, virtual key, or touch screen), storage unit (example: memory), communication unit (example: RF receiving section, RF transmitting section, transceiver), audio outputting section (example: speaker, mike), and control unit (example: processor), and it can omit at least one of these components or additionally possess other components.

FIG. 2 is the block diagram of the server 100 which controls the output of sequence information in accordance with the various embodiments of this invention.

According to the various embodiments, the server 100 can include the input unit 110, display unit 120, storage unit 130, communication unit 140, and control unit 170. According to the various embodiments, the server 100 can be the device (example: electronic device) which can omit at least one of the components of FIG. 2 or additionally possess other component.

Input unit 110 can include a number of input keys and function keys with which the number and character information can be inputted and various functions can be set up. The function keys can include the direction key, side key and shortcut key, etc. In addition, the input unit 110 can generate the key signal inputted in connection with the control of user setup and function of server 100 and transmit it to the control unit 170. According to the various embodiments, the input unit 110 can be realized with the touch screen method. For example, the touch screen can be formed with LCD (Liquid Crystal Display), OLED (Organic Light Emitted Diode), and so forth, and it can be included in the input unit 110. The input unit 110 which contains this kind of touch screen can include the panel, sheet, or digitizer, and so forth which can receive general touch input, hovering input, gesture input, or electronic pen input, etc.

Display unit 120 can display various screens generated in accordance with the operation of output controlling function of sequence information in the server 100. The display unit 120 can output the requested screen to the display screen in response to the receiving of the request signal for the specific screen from the control unit 170. For example, the display unit 120 can provide the screen interface such as the home screen, standby screen, menu screen, or the screen related with the output controlling function of sequence information, etc.

Display unit 120 can be realized with the display module or touch screen method, and if the display unit 120 is realized with the touch screen method, the display unit 120 can be operated as the input unit 110. In addition, the input unit 110 and display unit 120 can be realized as the touch display screen. According to the various embodiments of this invention, the display unit 120 can make the user to have advance confirmation by outputting the corresponding object or sequence screen information prior to the transmitting of the object or sequence information constituted by the control unit 170 to the sequence information output device 200.

Storage unit 130 can store the data received or generated from the control unit 170 or other components. The storage unit 130 can include the memory, cash, buffer, and so forth, and it can be constituted with the software, firmware, and hardware, or the combination of at least more than two of these.

The storage unit 130 in accordance with various embodiments can store various information generated or inputted in the course of controlling the output of sequence information. For example, the storage unit 130 can store the information (example: standby application information, message, etc.) received from the user terminal 300 to the user information DB 131. This kind of user information DB 131 can be updated periodically or in real time.

According to the various embodiments, storage unit 130 can store the sequence information providing program 135. The sequence information providing program 135 can be constituted with the command, routine, or instruction which makes the output of sequence information of this invention controlled by the control unit 170 during the execution. This kind of sequence information providing program 135 can be the command which is constituted so as to perform the stage (or operation) of receiving the standby application information for using the service from the user terminal 300; the stage of determining the standby sequence of user with the basis of the above standby application information; the stage of generating the object related with the above standby application information; the stage of constituting the sequence information screen in which the above generated object and at least one object generated in advance are visually arranged in accordance with the standby sequence corresponded to each object; and the stage of transmitting the controlling signal which makes the information of the above constituted sequence information screen and the above sequence information screen displayed to the sequence information output device. In addition, the sequence information program 135 can include the command which is constituted so as to perform the operation of the control unit 170 which will be described later in accordance with the various embodiments of this invention.

The sequence information providing program 135 as above can be stored even in the storing media which can be read by computer. This kind of storing media includes all kinds of storing media in which program and data are stored so that they can be read by computer system. For example, ROM (Read Only Memory), RAM (Random Access Memory), CD (Compact Disk), DVD (Digital Video Disk)-ROM, magnetic tape, floppy disk, optical data storing device, flash memory device, and so forth can be included. In addition, this kind of storing device can be dispersed to the computer system connected with network so that the code which can be read by computer with dispersion method can be stored and executed.

In the case of communication unit 140, the communicating connection between the sequence information output device 200 and user terminal 300 is established by the server 100 through the network 150, 350, and data can be transmitted and received with at least one of the connected sequence information output device 200 and user terminal 300. The communication unit 140 can include at least one of the cellular module, WiFi module, BT module, GPS module, NFC module, mobile network module or RF module, for example. Furthermore, communication unit 140 can include communication module, RF transmission/reception module, or transceiver.

According to the various embodiments of this invention, communication unit 140 can receive the sequence application information, message, and location information of user terminal 300 from the user terminal 300. In addition, the communication unit 140 can receive the information received from the sequence information output device 200 through the input unit 210 of the sequence information output device 200. Furthermore, the communication unit 140 can receive the location information of user terminal 300 which is perceived through the sensor unit 260 of the sequence information output device 200.

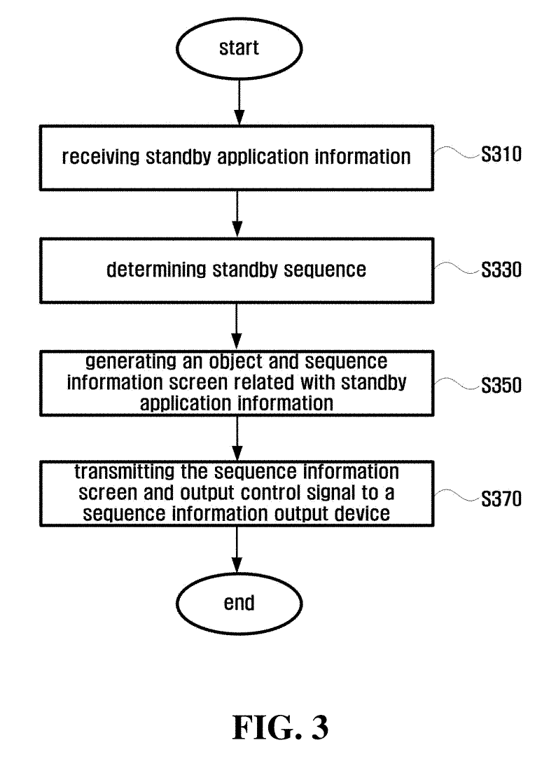

Control unit 170 can control the signal flow between the overall actions such as power supply control and internal constitution of server 100 and perform the data processing function which handles the data. The control unit 170 can include at least one processor and this kind of processor can include one or more of the central processing unit (CPU), application processor (AP), or communication processor (CP). Specific operation of the control unit 170 will be described later in detail with FIG. 3.

FIG. 3 is the flow diagram indicating the actions of controlling the output of sequence information from the server 100 in accordance with the various embodiments of this invention.

According to the various embodiments, the server 100 can receive, at S310, the standby application information from the user terminal 300. Specifically, control unit 170 can receive the standby application information from the user terminal 300 through the communication unit 140.

For example, user can provide sequence reception request, information for the number of people, and so forth for the specific restaurant with the server 100 by logging in through the application installed at the user terminal 300, and the control unit 170 can confirm the received standby application information and record it into the storage unit 130. This kind of standby application information can include at least one of the information for the number of people using the corresponding service, nickname of service user, location of the above user terminal, photograph image of user, and ID of user.

According to the various embodiments, the server 100 can determine, at S330, the standby sequence for the user of the user terminal 300 which requested the standby application information or of the user terminal 300. Specifically, in response to the reception of the standby application information, the control unit 170 can confirm whether there is another standby application information received before and the number of other standby application information, and can determine the standby sequence of the standby application information currently requested with the basis of the confirmed information.

For example, if the number of sequence reception requested for the lunch time of today for the specific restaurant is 3, the server 100 can determine the standby sequence of the user terminal 300 which requests current standby application information as No. 4.

According to the various embodiments, the server 100 can generate, at S350, the object related with the standby application information and standby information screen.

Specifically, the control unit 170 of server 100 can generate the object such as the visualized contents which can indicates the above user terminal 300 or the user (customer) of user terminal 300 with the basis of the standby application information received from the user terminal 300. The object can be the element for constituting the sequence information screen which allows customers to recognize the physical situation of the queuing in front of the store. According to the various embodiments, object can be the text, image, photograph, static image, dynamic image, thumbnail, or various types of UI item and can have various sizes and colors.

According to the various embodiments, the control unit 170 of server 100 can generate the object with the basis of at least one of the photograph image information of user, the image information automatically generated from the above server and the image information obtained through the sequence information output device 200.

For example, object can be the UI item in which the photograph image information of user is included. This kind of photograph image information of user can be transmitted from the user terminal 300 to the server 200 when user installs the application which is downloaded for using the function provided by the server 200 or inputs the standby application information, and the server 100 can store the photograph image information of user into the storage unit 130 or into the user information DB 131 of the storage unit 130.

For another example, when the standby application information from user terminal 300 is received, the control unit 170 can automatically generate image information with the algorithm set up in advance, and can also generate object by adding the generated image information itself or standby sequence, etc. The algorithm set up in advance can be, for example, the program set up so as to add the figures such as circle, ellipse, or polygon to the text which indicates the standby sequence, and can be embodied with various methods.

For another additional example, the control unit 170 can receive the image (example: photograph image) obtained by the sequence information output device 200 from the same sequence information output device 200, and can generate object with the basis of the received image. For this, the sequence information output device 200 can scan the photograph of user with the camera module, and can store the scanned photograph or transmit it with server 100.

According to the various embodiments, control unit 170 can constitute the sequence information screen with the basis of the generated object and at least one object generated in advance. In this occasion, the term at least one object generated in advance can be the object generated in the past with the basis of the standby application information received at least one of the other user terminals. In addition, the term at least one object generated in advance can be the object corresponded to the user still standing by and not being provided with the current service. The control unit 170 can delete the object corresponded to the user who is or is going to be provided with the service after the standby is finished.

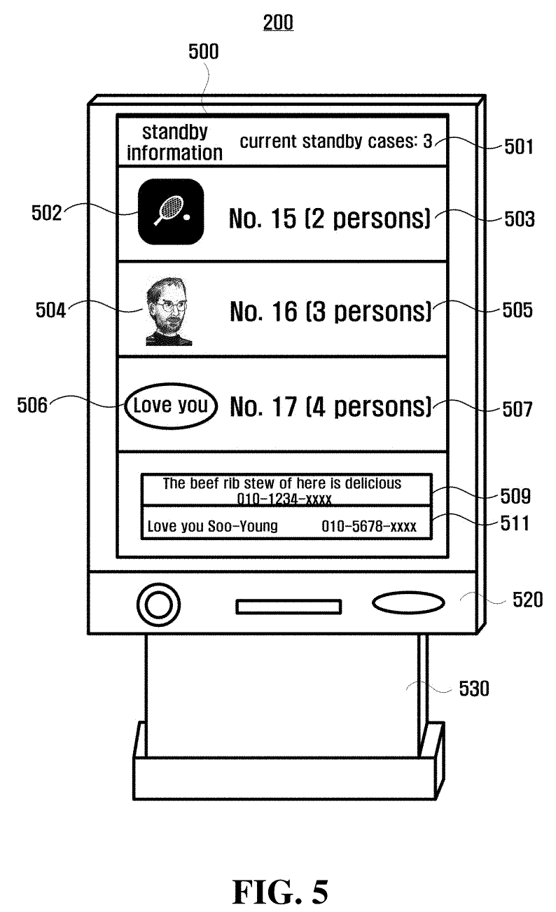

In addition, sequence information screen can be constituted so that generated object and at least one of the objects generated in advance will be arranged at least one direction. For example, so as to be visually disclosed as if a queue is generated by actual users in order to be provided with the service, the control unit 170 can constitute the sequence information screen so that the first generated object will be placed at the top or at the bottom, and the next generated object will be arranged at the lower or upper side of the first generated object. In this case, the space between the objects can be displayed with superimposed or overlapped fashion with each other. This kind of sequence information screen will specifically be described later with FIG. 5.

According to the various embodiments, control unit 170 can transmit the standby sequence of user terminal 300 and generated object to the user terminal 300 through communication unit 140. For example, the control unit 170 can transmit the information that the standby sequence generated for the user terminal 300 is No. 4 and the object constituted with the type of text “Love” which is generated with the basis of the above user terminal 300 to the user terminal 300. As mentioned previously, the object with the type of text “Love” can be requested from the user terminal 300 or automatically generated by the server 200. In accordance with this, the user who possesses the user terminal 300 can intuitively confirm where his sequence number is located by perceiving the area displayed with the sequence information (example: No. 4) or the object (example: love) from the sequence information output device 200 with the basis of the received information.

According to the various embodiments, control unit 170 can receive the location information of user terminal 300, and can control at least one output among the sequence information screens in which at least one object is included with the basis of the received location information. For this, the control unit 170 can receive the location information of user terminal 300 from sequence information output device 200 or user terminal 300 through communication unit 140.

For example, when the position of user terminal 300 is located within the distance set up in advance from sequence information output device 200, control unit 170 can confirm the object related with the user terminal 300 located within the above advance setup distance among the objects included in the sequence information screen. In this case, the control unit 170 can change the above confirmed object and at least one configuration among the sequence information screens in which the above confirmed object is included so that they will be distinguished with at least one object included in the sequence information screen. For instance, control unit 170 can constitute the sequence information screen in such a way that the confirmed object or the area adjacent to the confirmed object will be highlighted. The control unit 170 can transmit the control signal of outputting at least one changed contents among the changed object and changed sequence information screen to sequence information output device 200 through communication unit 140.

As described above, by changing the object outputted from sequence information output device 200 or the constitution of sequence information screen with the basis of the location information of user terminal 300, service provider (example: the owner of store etc.) can intuitively confirm whether the person with approached standby sequence is present in the vicinity through the screen of sequence information output device 200. In this case, if the user with approached standby sequence is not present in the vicinity, the service provider can transmit the notifying information which informs that the standby sequence is approached to the terminal of corresponding user.

According to the various embodiments, the server 100 can, at S370, transmit the sequence information screen and output control signal to sequence information output device 200. Specifically, control unit 170 can transmit the sequence information screen including at least one object to sequence information output device 200 through communication unit 140, and can transmit the control signal to the sequence information output device 200 so that the transmitted sequence information screen will be outputted.

According to the various embodiments, server 100 can receive the message from user terminal 300. Specifically, control unit 170 can receive the message (example: character message or voice message) from user terminal 300 through communication unit 140, and can transmit the control signal of outputting the received massage and message to sequence information output device 200. In this case, the control unit 170 can transmit the control signal to the sequence information output device 200 so that the message and the above message will be included in the sequence information screen or they will be displayed at the location adjacent to the above sequence information screen.

For example, in order to provide enjoyable moment to the people watching the sequence information output device 200 like kiosk, control unit 170 can transmit the control signal of outputting the telephone number of the user terminal 300 which transmitted the message received from the specific user terminal 300 (example: “Love you, Soo Yeong”) and corresponded message. In this case, for the protection of personal information, the control unit 170 can control the sequence information output device 200 so that some contents among the telephone numbers of user terminal 300 will be outputted with security processing (example: XXXX).

According to the various embodiments, the server 100 can control so that the screen outputted from sequence information output device 200 will be outputted from corresponded SNS server by interlocking with at least one server of Social Network Service (to be referred to as “SNS server” hereafter). For example, the server 100 can make the screen outputted from the sequence information output device 200 like kiosk interlocked with the above server 100 or can share the sequence information screen periodically or in real time with other users through the FACEBOOK™ subscribed to the above server 100 account. In accordance with this, users can conveniently confirm the sequence information not only through the off line but also through the online space such as SNS.

According to the various embodiments, server 100 can provide notifying information to the user terminal 300 related with the corresponding standby sequence at the time when the specific standby sequence is arrived. Specifically, control unit 170 can transmit the sequence arriving information to user terminal 300 through communication unit 140 at the time corresponded to the standby sequence. This kind of sequence arriving information can imply the information that service can be provided as the standby sequence of user terminal 300 is arrived.

For example, when the sequence of user terminal 300 whose standby sequence is No. 4 is arrived, control unit 170 can transmit the sequence arriving information “Your sequence is ready” to the user terminal 300.

In addition, server 100 can re-constitute the object related with corresponded standby sequence or sequence information screen at the time corresponded to the standby sequence. Specifically, control unit 170 can constitute or re-constitute sequence information screen and transmit it to sequence information output device 200 at the time corresponded to the standby sequence so that the object corresponded to standby sequence will be displayed with distinguished shape from other objects on the sequence information screen.

For example, when the sequence of user terminal 300 with the standby sequence of No. 4 is arrived, control unit 170 can modify the existing sequence information screen or constitute a new sequence information screen so that the object corresponded to No. 4 will be highlighted, and can transmit the modified or newly constituted sequence information screen to sequence information output device 200.

According to the various embodiments, when standby application information or standby sequence is complied with the conditions set up in advance, the control unit 170 of server 100 can issue the discount coupon to user terminal 300 through communication unit 140. The advance setup conditions can include, for example, at least one of the situations that the standby application information is the one received from the previous user terminal registered to the server 100, the position of the above user terminal 300 is located within the distance set up in advance from the above sequence information output device 200, or the standby sequence is higher than the sequence set up in advance. In accordance with this, the effect of service advertisement can be maximized by issuing adequate compensation to the users of using the server 100 of this invention more than twice, or conducting the standby application after coming near to the sequence information output device 200 located adjacent to the store, or having to stand by too long.

FIG. 4 is the block diagram of sequence information output device 300 which outputs the sequence information in accordance with the various embodiments of this invention.

Sequence information output device 200 can include input unit 210, display unit 220, storage unit 230, communication unit 240, audio processing section 250, sensor unit 260, and control unit 270. According to the various embodiments, the sequence information output device 200 can be the device (example: electronic device) which can omit at least one of the components of FIG. 4 or additionally possess another component.

According to the various embodiments, at least a part of sequence information output device 200 can be identical or similar to the constitution of server 100. For example, the input unit 210, display unit 220, storage unit 230, communication unit 240 of sequence information output device 200 can be identical or similar to the input unit 110, display unit 120, storage unit 130, communication unit 140 of server 100.

Audio processing unit 250 can be constituted so that various audio signals generated during the course of operating the sequence information output device 200 will be processed. For instance, the audio processing unit 250 can include the speaker in order to support the audio signal output transmitted from server 100. In addition, audio processing unit 250 can include the mike which can collect audio signal in order to support recording function, etc. According to the various embodiments, the audio processing unit 250 can output the notifying sound (e.g., effecting sound or guiding sound, etc.) in accordance with the outputting of sequence information screen of users from sequence information output device 200.

Sensor unit 260 can include the sensor module which can convert measured or perceived information into electric signal by measuring the physical quantity or detecting the operation state of sequence information output device 200. This kind of sensor unit 260 can include, for example, at least one of the GPS sensor, gesture sensor, atmospheric pressure sensor, magnetic sensor, proximity sensor, bionic sensor, infrared sensor, UV sensor, or illumination sensor. The sensor unit 260 can additionally include the control circuit to control the built-in sensors. In this invention, the sensor unit 260 can obtain related information (example: location information) from user during the course of outputting the sequence information screen of users.

Control unit 270 can perform the data processing function which controls overall operations such as power supply control, and so forth and the signal flow between internal components of sequence information output device 200 and processes the data. The control unit 270 can include at least one processor, and this kind of processor can include one or more of the central processing unit (CPU), application processor (AP), or communication processor (CP).

Even if it is not illustrated, according to the various embodiments, sequence information output device 200 can scan the photograph of user through the above camera module by additionally possessing the camera module. Specifically, when photographing request is inputted from user through the input unit 210 of sequence information output device 200, control unit 270 can obtain the photograph information of the above user by activating the camera module, and can transmit the obtained photograph information to server 100 through communication unit 240. This kind of photograph information can be utilized during the course of object generation.

For example, the users who stand by around the sequence information output device 200 such as the kiosk installed in front of the store can take photographs through the input button of kiosk, and the taken photographs are transmitted to server 100, and object can be generated by the server 100 with the basis of this. In accordance with this, the environment which makes the users standing by around the store enjoy the waiting time can be provided.

According to the various embodiments, sequence information output device 200 can detect the location information of user terminal 300 through sensor unit 260. For example, the control unit 270 of sequence information output device 200 can detect the user terminal 300 located within the distance set up in advance from the constitution of the sensor unit 260 such as the proximity sensor 260, and can transmit the detected information to server 100 through communication unit 240 as location information.

FIG. 5 is the illustration diagram which shows the sequence information output device 200 in accordance with the various embodiments of this invention. For the convenience of explanation, the description will be conducted for the kiosk as an illustration of sequence information output device 200.

As illustrated by the diagram, sequence information output device 200 can include sequence information screen 500, input module 520, and body 530. The sequence information screen 500 can be constituted at least at some area of the unit extended from the body, and this kind of sequence information screen 500 can be materialized at least as some of the physical area of display unit 120.

The input module 520 can be at least a part of the physical area of input unit 210, and can be the means to be manipulated by user or the one into which a specific request is inputted by user. The body 530 can include the type of stand so that it can be stood in the vicinity, and so forth of the store, however, various embodiments of this invention will not limited to this.

According to the various embodiments, sequence information screen 500 can contain the area 501 which includes the number of cases currently standing by and the title “standby information”, the area 503 which includes a first object 502 and the sequence information No. 15 for the first object 502 and the information for the number of people to use the service (2 persons), the area 505 which includes a second object 504 and the sequence information No. 16 for the second object 504 and the information for the number of people to use the service (3 persons), the area 507 which includes a third object 506 and the sequence information No. 17 for the third object 506 and the information for the number of people to use the service (4 persons), and the message output area 509, 511. As illustrated by the above sequence information, for the standing by persons started from the sequence information of No. 1, it can be understood that up to the No. 14 are used or are going to use the service currently.

A first object 502 can be embodied as the contents of tennis racket and ball shape, and a second object 504 can be embodied as the image information of user, and a third object 506 can be embodied as the shape of the text like “Love”. By constituting the objects into various shapes such as these, users can emphasize the characters of themselves without feeling any boredom. In addition, even if the queue is not created by actual users in front of the store or restaurant, by outputting virtual line information arranged in the specific direction of multiple numbers of objects, the effect of advertisement for the store providing the corresponding service can be accomplished.

In addition, the message transmitted by user to server 100 through user terminal 300 can be displayed. This kind of message can outputted with the specific comment to the corresponding restaurant like “The beef rib stew of this restaurant is delicious” or with various contents desired by user like “Love you, Sooyeong”. As described in this illustration, by outputting the message transmitted by users standing by around the kiosk through the message output area 509, 511, the absorption level for the standby users and enjoyment can be increased.

In addition, though not illustrated specifically, as the area that includes a first object 502 and the sequence information No. 15 for the first object 502 and the information for the number of people to use the service (2 persons) is corresponded to the current sequence, it can be highlighted for display.

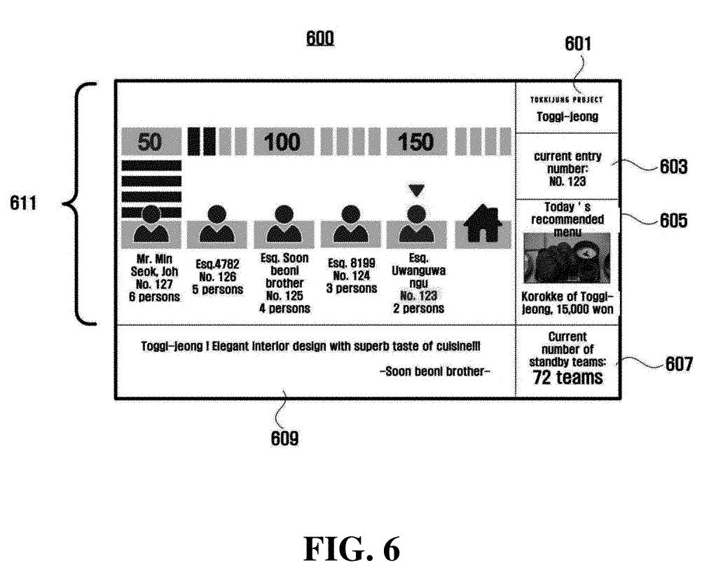

FIG. 6 is the illustration diagram which shows sequence information screen 600 in accordance with the various embodiments of this invention. The sequence information screen 600 illustrated in FIG. 6 can be the embodiment different from the sequence information screen 500 of FIG. 5.

As shown in the diagram, sequence information screen 600 can include service provider indication area 601, current entry number indication area 603, recommended service indication area 605, the number of current standby team information area 607, user review area 603, and object indication area 611.

Specifically, in the service provider indication area 601, the name of food service restaurant “Toggi-jeong” can be displayed. In addition, through the current entry number indication area 603, the information that the team corresponded to “No. 123” may be entered can be displayed. When referring to the object indication area 611, it can be understood that the object with the nickname “Esq. Uwanguwangu” and the image of specific shape is currently arrived at the sequence of entry. For this, the object corresponding to the above “Esq. Uwanguwangu” can be displayed by including or adding the information “No. 123” which is the current entry number, and at the same time, the information for the number of people “2 persons” can also be include or added for display. In addition, current entry sequence can implicitly be informed by displaying the object corresponded to the above nickname “Esq. Uwanguwangu” differently from other objects.

In addition, through the recommended service indication area 605, it can be displayed that the recommended menu of today is “Korokke of Toggi-jeong” in the restaurant “Toggi-jeong”. In this case, the photograph and price information for the corresponding recommended menu can be added for display.

In addition, through the number of current standby team information area 607, it can be displayed that the number of teams currently standing by is “72 teams”. When referring to the left section of the object indication area 611, it can be understood that the currently colored block will be ended between “50” to “100”. In this case, each block can be the one indicating the information of quantitative number corresponding to 10 teams, and the colored block can be the information for the number corresponding to 10 teams in standing by. Therefore, in order to indicate 72 teams which are the number of teams currently in standing by, it can be confirmed that two more colored blocks are displayed to the right side of the area displayed as “50”.

Through this kind of screen, how many people are currently standing by in the corresponded restaurant can be grasped by the people watching the above sequence information screen 600 of sequence information output device 200 even if actual queue is not currently created by people, and the effect of advertisement can be extended by the grasping.

In addition, through the user review area 609, the evaluation information for the corresponding service can be shared, and this kind of user review area 609 can perform the function similar to the message output area 509, 511 of FIG. 5.

The embodiments of this invention have been described as above, however, this invention is not limited to the above embodiments but it can be manufactured with various types which are different with each other, and it can be understood by the person with normal degree of knowledge in the field of the technology belonged to this invention that this invention can be conducted with other specific type without changing the technological idea or essential characteristic of this invention. Accordingly, it must be understood that the embodiments described above are illustrative and not restrictive in all respects.

The advertising effect for the corresponding service can be presented by providing the sequence information of users who are going to enjoy the specific service in accordance with the various embodiments of this invention as visual object through the sequence information output device located in the store.

In addition, there are advantages that the service use can conveniently be applied through the user terminal, and current sequence information of users can intuitively be recognized by the standing by users through the sequence information output device which outputs the sequence information.

Besides, there is the effect that the users can enjoy the standby time without feeling any sense of boredom by constituting and providing the object from which the sequence information can be recognized with various types of contents.

Furthermore, by outputting the messages transmitted by users together with the sequence information through the sequence information output device located in the store, the attention of users can be raised, and the environment in which the specific information for the corresponding store can be shared with other people can be provided.

While exemplary embodiments have been particularly shown and described, it will be understood by those of ordinary skill in the art that various changes in form and details may be made therein without departing from the spirit and scope of the present inventive concept as defined by the following claims.

What is claimed is:

1. A server of controlling output of sequence information, the server comprising:
a communication unit configured to receive standby application information for using a service;
a control unit configured to:
determine a standby sequence of user based on the standby application information;
generate an object related with the standby application information and configure a sequence information screen in which the generated object and at least one object generated in advance are visually arranged in accordance with the standby sequence corresponding to each of objects; and
transmit, through the communication unit, the configured sequence information screen and a control signal of controlling the configured sequence information screen to be outputted to a sequence information output device.

2. The server of claim 1, wherein the control unit is further configured to transmit the standby sequence and the generated object to a user terminal through the communication unit.

3. The server of claim 2, wherein the control unit is further configured to:
transmit a sequence arriving information to the user terminal though the communication unit at the time corresponding to the standby sequence; and
configure the sequence information screen such that the object corresponding to the standby sequence is displayed differently from other objects on the sequence information screen, and transmit the configured sequence information screen to the sequence information output device.

4. The server of claim 1, wherein the standby application information includes at least one of information for the number of people to use the service, nickname information of service user, location information of the user terminal, photograph image information of user, and ID information of user.

5. The server of claim 4, wherein the object related to the standby application information is generated based on at least one of:
the location information of the user terminal;
an image information automatically generated from the server; and
an image information obtained through the sequence information output device.

6. The server of claim 1, wherein the control unit is further configured to provide a discount coupon to the user terminal through the communication unit when the standby application information or the standby sequence meets a pre-set condition.

7. The server of claim 6, wherein the pre-set condition includes at least one of:
a condition that the standby application information is received from a previous user terminal registered to the server;
a condition that location of the user terminal is located within a pre-set distance from the sequence information output device; and
a condition that the standby sequence is equal to or greater than a pre-set sequence.

8. The server of claim 1, wherein the control unit is further configured to:
receive a message from the user terminal through the communication unit; and
transmit, to the sequence information output device, the message and a signal which controls the message to be included in the sequence information screen or to be outputted at a location adjacent to the sequence information screen.

9. The server of claim 8, wherein the control unit is further configured to transmit at least one of the sequence information screen and the received message to the SNS server through the communication unit so that at least one of the sequence information screen and the received message is to be shared with other users at the SNS server interlocked with the server.

10. A method for controlling output of sequence information, the method comprising:
receiving standby application information for using a service;
determining a standby sequence of user based on the standby application information;
generating an object related with the standby application information;
configuring a sequence information screen in which the generated object and at least one object generated in advance are visually arranged in accordance with standby sequence corresponded to each of the objects; and
transmitting, to a sequence information output device, the configured sequence information screen and a control signal which control the sequence information screen to be outputted.

11. A computer-readable storage media having a program configured to control outputting of sequence information, the program comprising:
receiving standby application information for using a service;
determining a standby sequence of user based on the standby application information;
generating an object related with the standby application information;
configuring a sequence information screen in which the generated object and at least one object generated in advance are visually arranged in accordance with standby sequence corresponded to each of the objects; and
transmitting, to a sequence information output device, the configured sequence information screen and a control signal which control the sequence information screen to be outputted.
